(19) United States
(12) Patent Application Publication
(10) Pub. No.: US 2008/0297158 A1
(43) Pub. Date: Dec. 4, 2008

(54) Gradiometric Directional Metal Detector

(75) Inventors: Charles E. Heger, Saratoga, CA (US); Anthony J. Rossetti, San Jose, CA (US)

Correspondence Address: Silicon Valley Patent Group LLP, 18805 Cox Avenue, Suite 220, Saratoga, CA, 95070, US

(73) Assignee: Zircon Corporation, Campbell, CA (US)

(21) Appl. No.: 11/756,609

(22) Filed: May 31, 2007

(51) Int. Cl. G01V 3/11; G01V 3/165

(52) U.S. Cl. 324/326; 324/233

(57) ABSTRACT

An implementation of a direction finding and magnetic nulling metal detector is provided. Some embodiments of the present invention provide for a metal detector having multiple resonant circuits and associated coils for transmitting a primary transmit signal, transmitting a magnetic nulling signal, and receiving a receive signal. A controller includes logic to process the generate the transmit signals and to process the received signal in order to determine a gradient vector along one or two dimensions, a depth and whether or not a metal object is ferrous.

### BACKGROUND OF THE INVENTION

1. Field of the Invention

The invention relates to tools and in particular to a metal detector, for finding a metallic object hidden behind a surface and for providing a directional indication.

2. Background of the Invention

Metal detectors are well known tools used to find ferrous and non-ferrous materials sometimes hidden behind or under a surface. For example, see U.S. Pat. No. 3,471,722, U.S. Pat. No. 3,823,365, U.S. Pat. No. 3,826,973, U.S. Pat. No. 3,882,374, U.S. Pat. No. 4,030,026, U.S. Pat. No. 4,110,679, U.S. Pat. No. 4,659,989, U.S. Pat. No. 4,667,384, U.S. Pat. No. 4,700,139, U.S. Pat. No. 4,709,213, U.S. Pat. No. 4,783,630, U.S. Pat. No. 4,868,910, and U.S. Pat. No. 5,729,143, each of which is incorporated by reference.

Such detectors often use an inductive coil for finding metal. The coil may be wound such that it occupies a 2-dimensional plane or near plane or alternatively may be wound laterally around a center cylinder. Some detector use two coils: a single coil for transmitting and a single coil for receiving.

Known metal detectors, however, do not provide indications of direction to a metal object and a depth to the metal object. Additionally, known metal detectors do not provide indications of an offset to a metal object and a depth to the metal object. Therefore, embodiments of the disclosed metal detector provide to an operator an indication of a direction, an offset and/or a depth to a hidden metal object.

### SUMMARY

Some embodiments of the present invention provide for a metal detector comprising: a first resonant circuit comprising a first coil, wherein the first resonant circuit is configured to transmit a first circuit transmit signal; a second resonant circuit comprising a second coil, wherein the second resonant circuit is configured to receive a second circuit receive signal; a third resonant circuit comprising a third coil, wherein the third resonant circuit is configured to receive a third circuit receive signal; and a controller comprising logic to determine a gradient, variable in at least one dimension, based on the second circuit receive signal and the third circuit receive signal.

Some embodiments of the present invention provide for a metal detector comprising: a first resonant circuit comprising a first coil and a transmit amplifier having an output coupled to the first coil, wherein the first resonant circuit is configured to transmit a first circuit transmit signal; a second resonant circuit comprising a second coil and a receive amplifier having an input couple to the second coil, wherein the second resonant circuit is configured to receive a second circuit receive signal; a third resonant circuit comprising a third coil and a secondary transmit amplifier having an output coupled to the third coil, wherein the third circuit is configured to transmit a third circuit nulling signal; and a controller comprising logic to determine the third circuit nulling signal based on the second circuit receive signal.

Some embodiments of the present invention provide for a method of determining a gradient relative to a metal detector and metal hidden behind a surface, the method comprising: transmitting, from a first resonant circuit, a first circuit transmit signal; receiving, from a second resonant circuit, a second circuit receive signal; receiving, from a third resonant circuit, a third circuit receive signal; and determining a gradient based on the second circuit receive signal and the third circuit receive signal.

These and other aspects, features and advantages of the invention will be apparent from reference to the embodiments described hereinafter.

### BRIEF DESCRIPTION OF THE DRAWINGS

Embodiments of the invention are described, by way of example only, with reference to the drawings.

FIG. 1 illustrates two coils of a metal detector.

FIG. 2 shows circuitry of a two-coil metal detector in the presence of a metal object.

FIG. 3 illustrates circuitry for electrical nulling in a receiver.

FIGS. 4A and 4B illustrate a secondary transmit coil used for magnetic nulling, in accordance with the present invention.

FIGS. 5A and 5B show three coils of a metal detector having one primary transmit coil and having two coils for both receiving a receive signal and transmitting a magnetic nulling signal, in accordance with the present invention.

FIG. 6 shows a block diagram of a three-coil metal detector, in accordance with the present invention.

FIG. 7 shows transmitter/receiver circuitry coupled to a controller, in accordance with the present invention.

FIGS. 8A through 8H illustrate waveforms associated with magnetic nulling, in accordance with the present invention.

FIGS. 9A through 9F show circuitry for incorporating magnetic nulling and gradient determination, in accordance with the present invention.

FIGS. 10A through 10E illustrate alternative coil configurations, in accordance with the present invention.

FIGS. 11A and 11B demonstrate a one-dimension-plus-depth display and a two-dimension-plus-depth display, in accordance with the present invention.

FIG. 12 shows a software block diagram of a metal detector, in accordance with the present invention.

FIGS. 13A, 13B, 14A and 14B illustrate moldings for holding coils in place for positional nulling, in accordance with the present invention.

### DETAILED DESCRIPTION OF THE INVENTION

In the following description, reference is made to the accompanying drawings, which illustrate several embodiments of the present invention. It is understood that other embodiments may be utilized and mechanical, compositional, structural, electrical, and operational changes may be made without departing from the spirit and scope of the present disclosure. The following detailed description is not to be taken in a limiting sense.

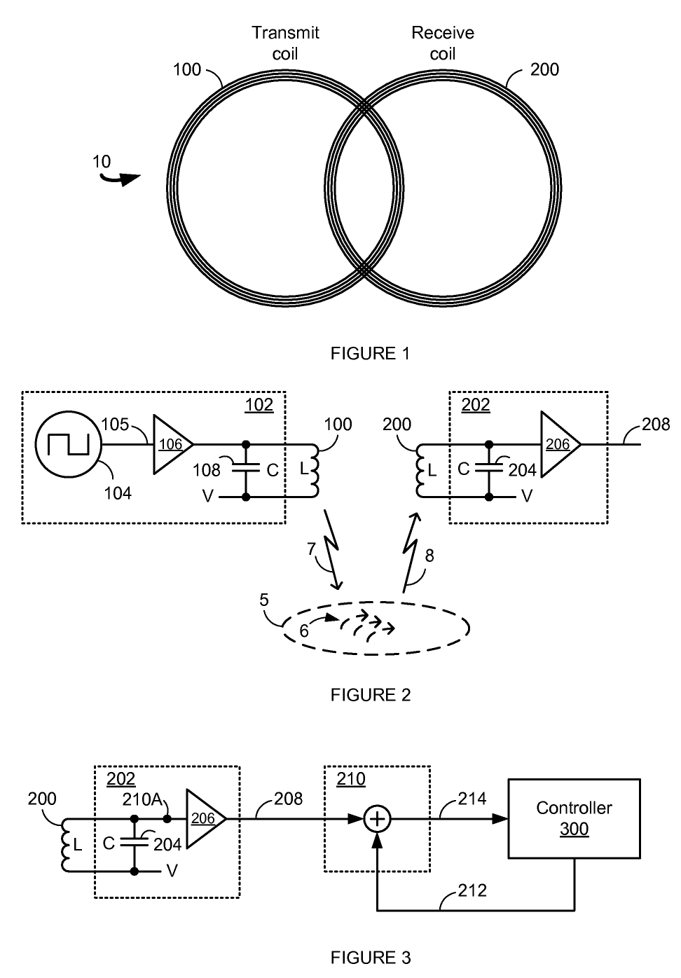

FIG. 1 illustrates a coil Configuration 10 of a metal detector having two coils: transmit coil 100 and receive coil 200. In Configuration 10, the coils are coplanar but are not coaxial and are formed, sized and positioned such that the receive coil 200 produces substantially no output signal in the absence of a metallic object. That is, the relative physical positioning of the transmit coil 100 and the receive coil 200 provides positional nulling.

In operation, the metal detector applies an alternating current to the transmit coil 100, which results in the transmit coil 100 sending out an RF signal and generating a primary electromagnetic field. Positional nulling is provided by the receive coil 200 physically positioned so that it nulls out this signal and electromagnetic field. Both ferrous and nonferrous metal objects disrupt the electromagnetic field produced by the transmit coil 100; however, in different manners. In the case of ferrous objects, the magnetic field is concentrated by the ferrous object. In the case of a nonferrous object, eddy currents are produced in the object that, in turn, produce magnetic fields. The eddy current produced magnetic fields dissipate the magnetic field produced by the transmit coil, in the region of the object. In either case, the magnetic field produced by the transmit coil is disrupted in a manner that generates a voltage in the receive coil 200, which is 90 degrees out of phase with the primary signal.

Positional nulling is further described in U.S. Pat. No. 3,471,773 (entitled “Metal detecting device with inductively coupled coaxial transmitter and receiver coils” to Penland), U.S. Pat. No. 3,882,374 (entitled “Transmitting-receiving coil configuration” to McDaniel), and U.S. Pat. No. 4,507,612 (entitled “Metal detector systems for identifying targets in mineralized ground” to Payne), each of which are herein incorporated by reference.

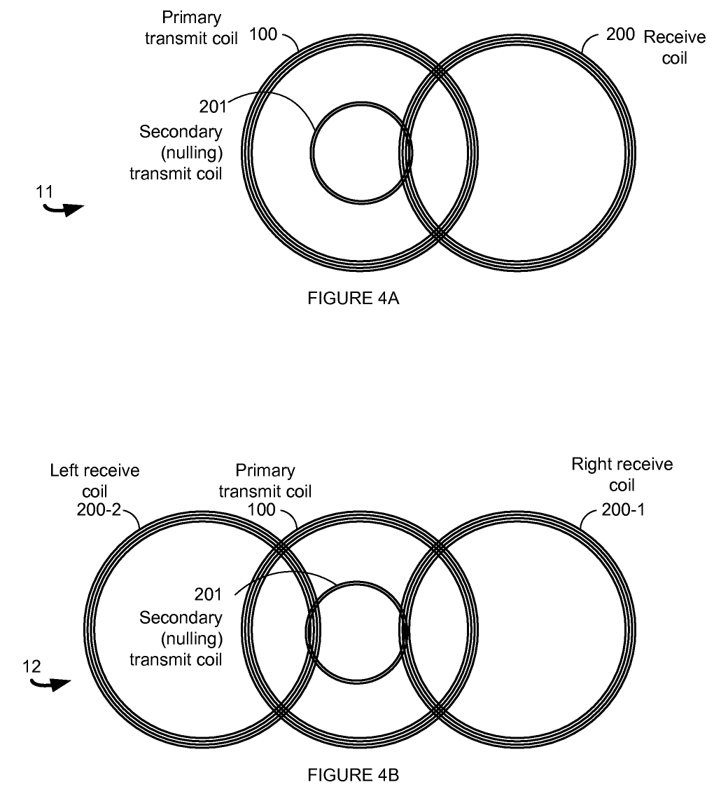

FIG. 2 shows transmit circuitry 102 and receive circuitry 202 of a two-coil metal detector in the presence of a metal object 5. Transmit circuitry 102 is connected to the transmit coil 100 and includes an oscillator 104, an amplifier 106 and a capacitor (C) 108. An output terminal of the oscillator 104 is connected in an input terminal of the amplifier 106. An output terminal of the amplifier 106 is connected to a first terminal of a tank circuit formed with the capacitor 108 connected in parallel to the transmit coil 100. Receive circuitry 202 includes a capacitor (C) 204 and an amplifier 206. The capacitor 204 is connected in parallel to the receive coil 200 to form another tank circuit. A first terminal of the tank circuit is connected to an input terminal of the amplifier 206. A second terminal of each tank circuit is connected to a source of a reference voltage (V) such as ground or an intermediate or middle voltage (e.g. V_{M}=½V_{MAX}).

The oscillator 104 generates a driving signal 105, such as a sinusoidal or square wave signal, that is amplified by amplifier 106, fed to the tank circuit and transmitted through the transmit coil 100 as an electromagnetic signal 7. In an example of a nonferrous object, the electromagnetic signal 7 causes eddy currents 6 in the metal object 5. The eddy currents cause a secondary electromagnetic signal 8, which is received by the receive coil 200. The receive coil 200 and receive circuitry 202 receive the secondary electromagnetic signal 8 and produces a received signal 208.

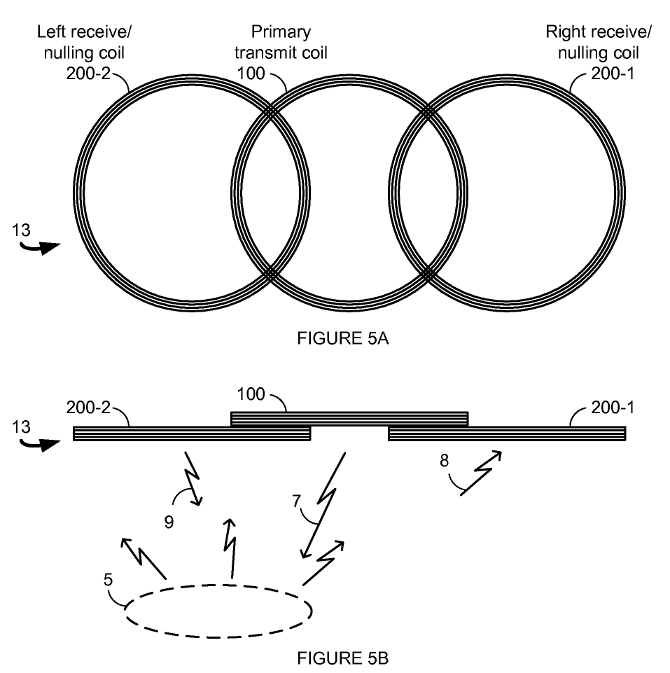

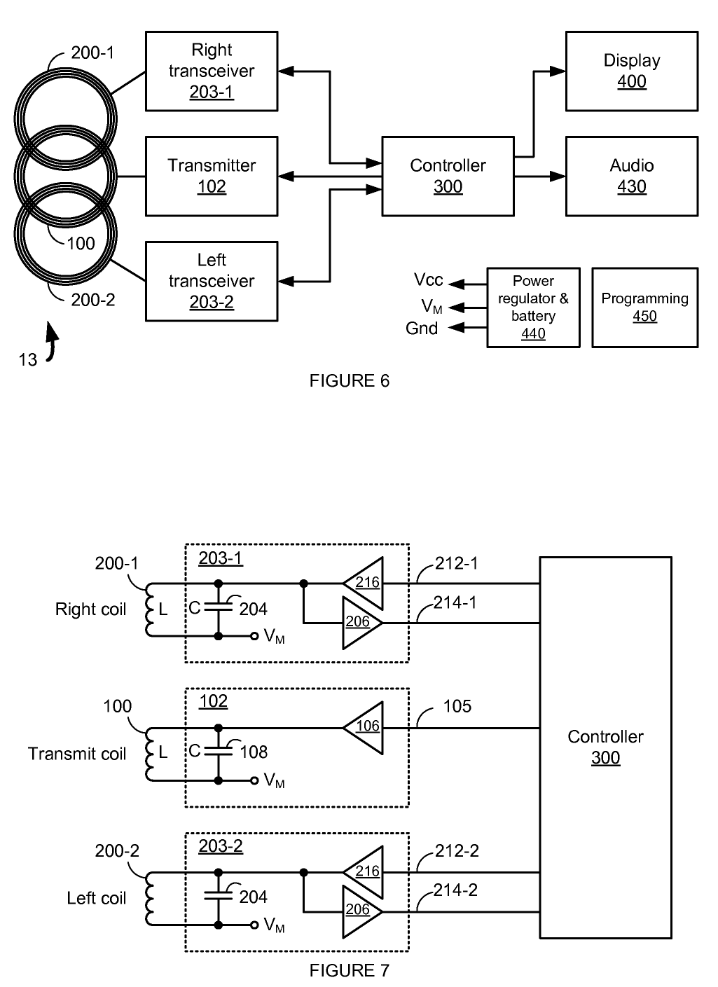

If the transmit coil 100 and receive coil 200 are not precisely aligned an unbalance situation will exist. In this case, a small about of magnetic leakage from the transmitter may cause the receiver to register a signal when no metal object is in the vicinity. To compensate, a metal detector may include secondary electrical and/or magnetic nulling correction circuitry. Circuitry providing electrical nulling is described below with reference to FIG. 3. Circuitry providing magnetic nulling or electromagnetic field nulling is described below with reference to FIGS. 4A and 4B.

As described below, electrical nulling is performed with a coil that is currently receiving a receive signal and magnetic nulling is performed with a coil not currently receiving a receive signal but rather transmitting a magnetic nulling signal. Therefore, a coil and accompanying circuitry may be used for both electrical nulling and magnetic nulling though at different phases of operation. Some embodiments of the present invention include both electrical nulling and magnetic nulling, both described below. Other embodiments of the present invention do not include electrical nulling but do include magnetic nulling.

FIG. 3 illustrates circuitry for electrical nulling in receive circuitry 202. An adder 210 has a first input terminal connected to a conductor with the received signal 208 from receive circuitry 202, a second input terminal connected to an electrical nulling signal 212 from a controller 300, and an output terminal connected to an input terminal of the controller 300. The adder 210 sums the received signal 208 to the electrical nulling signal 212 and generates a summed signal 214, which it sends to the controller 300. The controller 300 determines the electrical nulling signal 212 during calibration to compensate for any misalignment between the transmit coil 100 and the receive coil 200.

In an alternative embodiment, the adder 210 is connected before, rather than after, the amplifier 206 at 210A. In this alternative embodiment, the electrical nulling signal 212 is combined with a signal from the receive tank circuit then is amplified through the amplifier 206. The combined and amplified signal is fed to the controller 300.

The adder 210 may be an analog component or alternatively may operate on digital data. Additionally, the adder 210 may be a component within the controller 300. The controller 300 may have on-board analog-to-digital converters (ADCs) or ADCs may be separate components.

FIGS. 4A and 4B illustrate a secondary transmit coil or auxiliary coil used for magnetic nulling, in accordance with the present invention. Configuration 11 in FIG. 4A shows the transmit coil 100 and receive coil 200 of Configuration 10 of FIG. 1 with the addition of a secondary transmit coil 201. The coils 100, 200 and 201 may be air-core coils, for example, having a diameter of 1 inch to 2 inches for targeting metal objects within 6 inches from the coils. For deeper metal objects, larger diameter coils may be used.

The secondary transmit coil 201 may be positioned at or near the center of the primary transmit coil 100. Alternatively, the secondary transmit coil 201 may be positioned partially outside or fully outside the primary transmit coil 100. The secondary transmit coil 201 is used to compensate for in any misalignment detected by the controller 300 during operation. Depending on the polarity of the signals in the primary transmit 100 and receive coil 200 as well as the direction of misalignment the signal transmitted from the secondary transmit coil 201 may be lead to too much overlap or not enough overlap for full positional nulling. A controller drives the secondary transmit coil 201 with a signal of an amplitude and phase so that a magnetic field of the correct size and phase is created to cancel or minimize the received signal caused directly by the transmit signal.

Configuration 12 in FIG. 4B shows the primary transmit coil 100, a right to receive coil 200-1 and a left receive coil receive coil 200-2 as well as a secondary transmit coil 201. Again, the secondary transmit coil 201 is shown positioned at or near the center of the primary transmit coil 100 where the centers of each of the coils form a line. In operation, the primary transmit coil 100 transmits a signal while the either one of two receive coils is active. If the right receive coil 200-1 is active, the secondary transmit coil 201 transmits a signal to compensate for misalignment between the primary transmit coil 100 and the right receive coil 200-1. When the left receive coil 200-2 is active, the secondary transmit coil 201 transmits a signal to compensate for misalignment between the primary transmit coil 100 and the left receive coil 200-2. In this manner, the secondary transmit coil 201 provides two magnetic nulling signals 212, each at different times, to minimize a signal received.

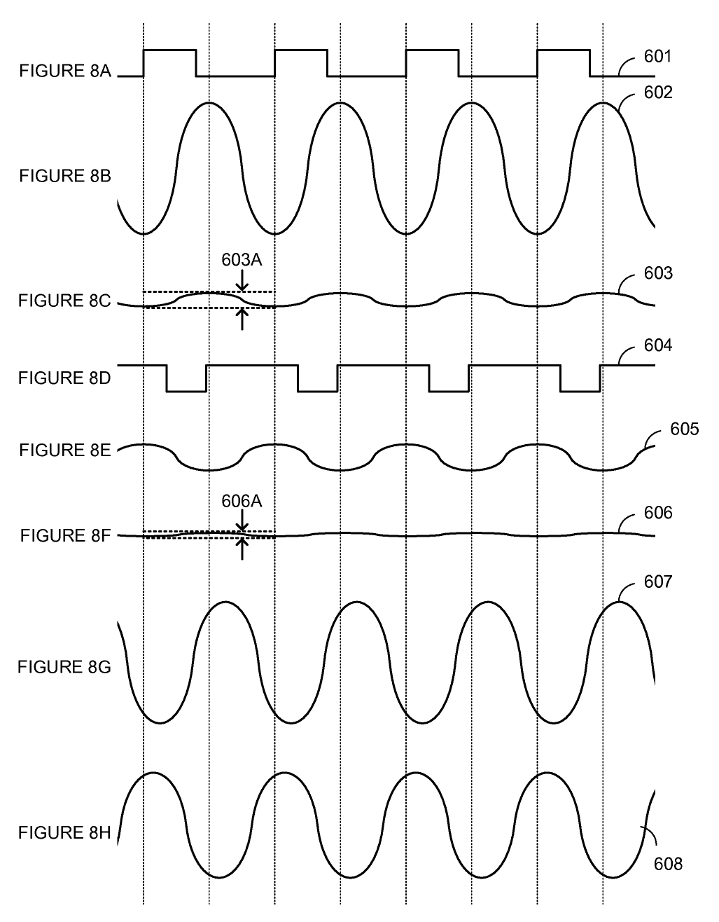

FIGS. 5A and 5B show three coils of a metal detector having one primary transmit coil and having two coils for both receiving a receive signal and transmitting a magnetic nulling signal, in accordance with the present invention. In these embodiments, magnetic nulling occurs by reusing an unused receive coil 200. In other words, during a phase of operation when a coil is not being used as a receive coil to receive a receive signal, it may be used to transmit a magnetic nulling signal.

In Configuration 13 of FIG. 5A, a top of view shows the centers of each of the coils form a line with the primary transmit coil 100 between the right and left coils 200-1 and 200-2. A goal of manufacturing is to position the right and left coils 200-1 and 200-2 overlapping with the primary transmit coil 100 such that a signal transmitted from the primary transmits coil 100 is nulled when received by either the right coil 200-1 or the left coil 200-2. Due to limitations in manufacturing such as typical tolerances and practical variances in physical dimensions and electronic components, the primary transmit coil 100 might not be precisely position with respect to a receiving coil to provide perfect nulling. Due to this misalignment, the transmit signal couples into the receive signal and possibly leads to overloading of the receive signal path even when no metal object is nearby. Magnetic nulling as described herein aides in preventing such overload.

The two coils 200 may have dual use: first as a receiving coil and second as a magnetic nulling coil. In operation, the primary transmit coil 100 operates with either of the two coils 200. One of the two coils 200 receives a receive signal while the other of the two coils 200 transmits a magnetic nulling signal. For example, when the right receive coil 200-1 is being used to detect the presence of a metal object (receiving coil), the left receive coil 200-2 may be used to transmit a magnetic nulling signal (transmitting coil). At a later time, the left receive coil 200-2 may be used to detect the presence of a metal object, while the right receive coil 200-1 is used to transmit a magnetic nulling signal.

FIG. 5B shows a second perspective of Configuration 13. From this angle, the primary transmit coil 100 is seen stacked above the right and left receive coils 200-1 and 200-2, which lie in a common plane. Initially, the metal detector calibrates the three coils away from any metal objects. During calibration, the transmit coil 100 transmits an electromagnetic signal 7. If right receive coil 200-1 detects a non-zero signal 8, the controller generates a magnetic nulling signal and transmits that magnetic nulling signal 9 from the left receive coil 200-2. The controller adjust the magnetic nulling signal 9 to minimize the signal received by the right receive coil 200-1. In operation over a metal object 5, the primary transmit coil 100 transmits an electromagnetic signal 7 and the left receive coil 200-2 transmits the magnetic nulling signal 9 calibrated previously as described above. When an operator moves the metal detector near the metal object 5, the metal object 5 is subject to the primary transmit signal 7 and, to a lesser extent, the magnetic nulling signal 9. The metal object 5 acts to provide an image signal 8 that is received by the right receive coil 200-1.

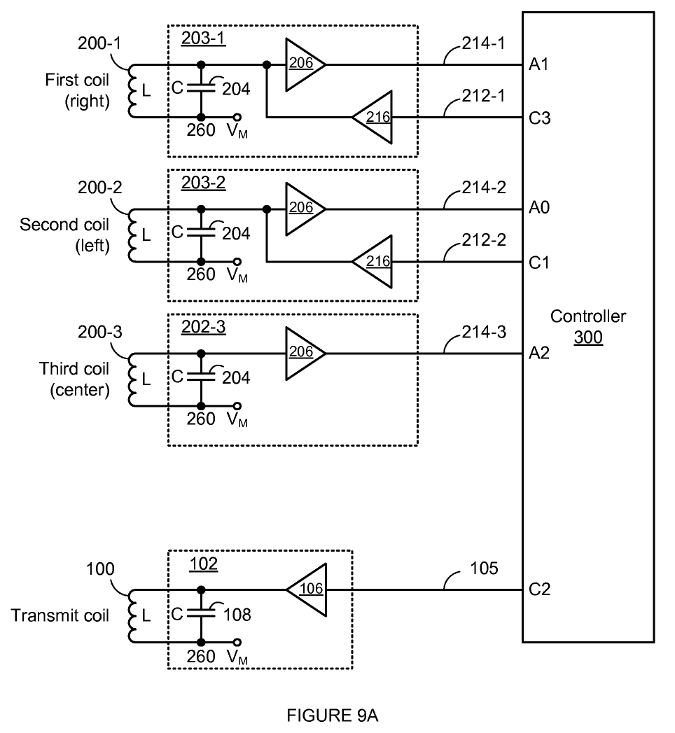

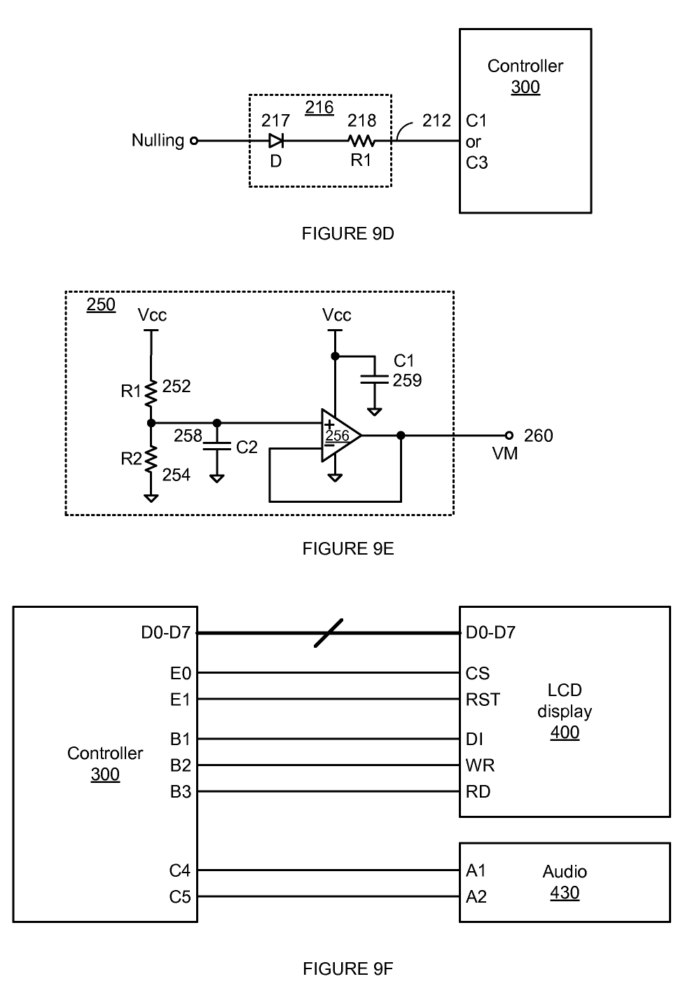

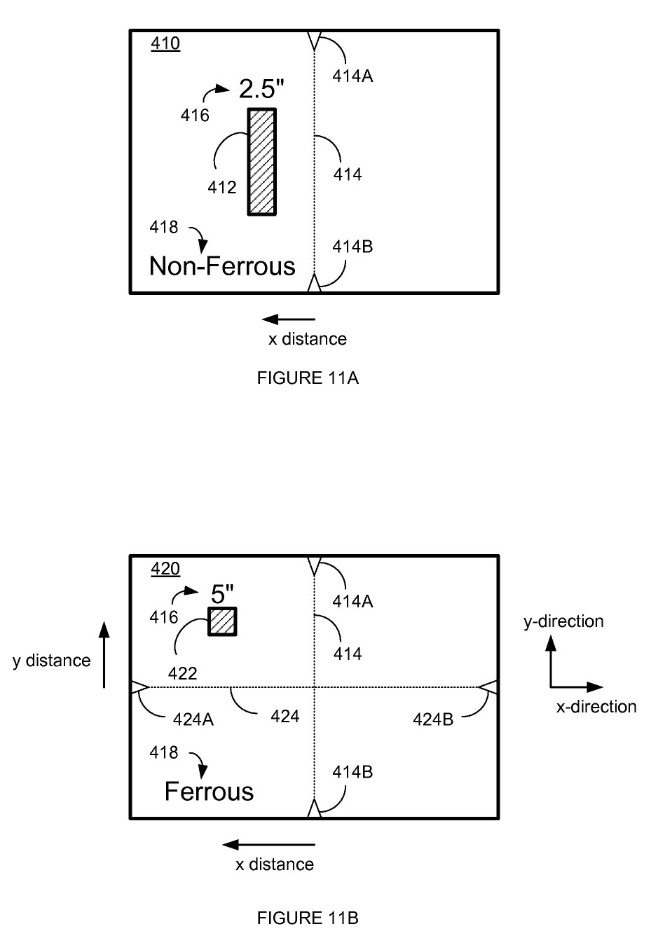

The transmit circuitry 102, receive circuitry 202 and controller 300 may be formed with various combinations of digital logic and analog logic. FIGS. 6, 7 and 9A-9F show hardware embodiments for a metal detector. FIGS. 8A-8H show signaling waveforms associated with the hardware described. FIGS. 10A-10E show alternative coil configurations equally adaptable to the hardware embodiments described below.

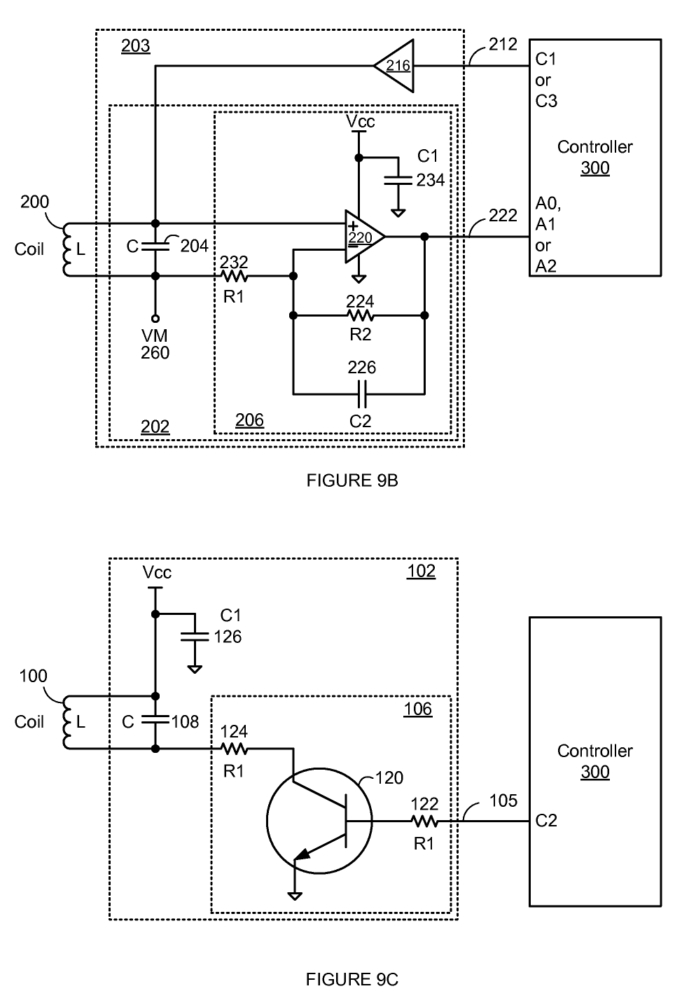

FIG. 6 shows a block diagram of a three-coil metal detector, in accordance with the present invention. The three-coil metal detector includes a transmit coil 100 and associated transmit circuitry 102, a right receive coil 200-1 and associated right transceiver circuitry 203-1, and a left receive coil 200-2 and associated left transceiver circuitry 203-2, which are described in additional detail below with reference to FIG. 7. The metal detector also includes a controller 300, display circuitry 400, audio circuitry 430, power regulator and battery circuitry 440 and programming circuitry 450.

The controller 300 maybe a microcontroller, a microprocessor, an ASIC or the like. For example the controller 300 may be a peripheral interface controller (PIC) device such as a 8-bit or 16-bit processor from Microchip Technology Inc. The power regulator and battery circuitry 440 provides a reference voltage (e.g., voltage middle V_{M}), a high voltage source (e.g., Vcc), and a low voltage source (e.g., ground). The power regulator and battery circuitry 440 may include a battery and/or a power supply for connection to an outlet. The optional programming circuitry 450 allows for configuration of software used by the controller 300. For example, the programming circuitry 450 may include a bus interface to a flash memory on the controller 300. The programming circuitry 450 may include random access memory and/or programmable read only memory. In some embodiments, programming memory is included within the controller 300.

FIG. 7 shows transmitter/receiver circuitry coupled to a controller 300, in accordance with the present invention. The circuitry includes a transmit coil 100, transmit circuitry 102, a right receive coil 200-1, right transceiver circuitry 203-1, a left receive coil 200-2, and left transceiver circuitry 203-2. The transmit circuitry 102 includes a capacitor 108 and a primary transmit amplifier 106. The capacitor 108 is connected in parallel to the transmit coil 100 to form a resonant circuit. In some embodiments, the coil 100 and capacitor pair is designed to resonate at 5500 Hz. The primary transmit amplifier 106 has an output port providing a signal to a first end of the transmit coil 100 and an input port accepting a signal 105 from the controller 300. The second end of the transmit coil 100 is shown connected to a reference voltage, such as V_{M}. The primary transmit amplifier 106 amplifies the signal 105 to produce a transmit signal at its output port. In some embodiments, a peak-to-peak voltage level (V_{PP}) of a typical transmit signal applied to the resonant circuit is approximately 6 volts.

Each transceiver circuitry 203 (203-1 and 203-2) includes a capacitor 204, a receive amplifier 206 and a transmit amplifier 216. The capacitor 204 is connected in parallel to the respective receive coil 200 (200-1 and 200-2) to form a respective resonant circuit. Each coil 203-capacitor 204 pair is designed to resonate with the transmit resonant circuit (e.g., at 5,500 Hz). The receive amplifier 206 has an input port connected to the first end of the resonant circuit and an output port connected to the controller 300 to provide a received signal 214 (214-1 and 214-2). The transmit amplifier 216 has an input port connected to the controller 300 to accept a magnetic nulling signal 212 (212-1 and 212-2) and an output port connected the first end of the resonant circuit.

While the coil 200-1 is being used to receive the signal 214-1, the receive amplifier 206 is actively providing the receive signal 214-1 to the controller 300 and the transmit amplifier 216 is disabled. In some embodiments, the receive amplifier 206 amplifies the receive signal from the resonant circuit between 50 to 200 times to approximately 0.1 to 1.0 V_{PP} when no metal is nearby. As a metal object nears the metal detector, the amplitude of the receive signal increases to several times the receive signal level when no metal is nearby. Additionally, as described above, the phase of the received signal will be advanced or retarded as a result of the metal object being ferrous or non-ferrous. While the coil 200 is being used to transmit the signal 212-1, the receive amplifier 206 is disabled and the transmit amplifier 216 is actively providing the magnetic nulling signal 212-1 from the controller 300 to the resonant circuit and coil 200.

The second end of the receive coil 200 is shown connected to a reference voltage, such as V_{M}. By selecting a reference voltage between a maximum voltage (e.g., V_{CC}) and a minimum voltage (e.g., ground), the magnetic nulling signal 212 driving to the resonant circuit has a relative DC offset from V_{M} that is either positive or negative. Such control allows for adjustment of the polarity of the transmitted electromagnetic signal. For example if during calibration transceiver circuitry 203-1 receives a non-zero signal 214-1, second transceiver circuitry 203-2 may transmit a magnetic nulling signal 212-2 having the appropriate polarity to null an erroneous signal 105 from the transmit coil 100.

In some embodiments, an A-to-D converter synchronously samples the receive signal 214 with respect to a D-to-A converter generating the transmit signal 212. The resulting detected voltage of the received signal 214 at the point in time of sampling depends on the distance and direction to the metal object and type of metal object being sensed. In operation, the controller 300 reads the voltage for each receive coil 200 in an A-to-D converter and uses the values to calculate the signal strength, direction and metal type to a user through a user interface (e.g., display and/or audio device). The user interface may be graphical and may use the movement, location, sizes and/or colors of geometric elements and text to display the information to the user.

FIGS. 8A through 8H illustrate waveforms associated with magnetic nulling, in accordance with the present invention. The waveforms are illustrative and not waveforms captured by test equipment. Therefore, captured waveforms may differ in terms if relative amplitudes, duty cycles, relative frequencies and relative phase differences.

FIG. 8A shows a waveform 601 representing a transmit signal 105. Waveform 601 is shown as a square wave having a duty cycle. Alternatively, sinusoidal, triangular and other known waveforms may be used. In some embodiments, waveform 601 is a constant signal. Waveform 601 is supplied as transmit signal 105 to an input port of the primary transmit amplifier 106. The primary transmit amplifier 106 uses the transmit signal 105 at its input port to develop a driving signal at its output port. This driving signal drives the resonant circuit formed with the transmit coil 100 and capacitor 108.

FIG. 8B shows a waveform 602 representing a ringing signal formed across the resonant circuit. The steady-state form of the ringing signal is defined by frequency, amplitude and duty cycle of the transmit signal 105, the gain characteristics of the primary transmit amplifier 106, the inductance of the transmit coil 100, and the capacitance of the capacitor 108. For example, the frequency of waveform 602 is determined by the frequency of signal 601. The amplitude of waveform 602 may be controlled by the duty cycle of signal 601 or by control of the gain of the transmit signal 105. The resulting waveform 602 is transmitted from the transmit coil 100 and creates an electromagnetic signal 7 (of FIG. 2). In some embodiments, the frequency of the electromagnetic signal 7 is designed to be 5,500 Hz. In some embodiments, the electromagnetic signal 7 is continuously transmitted while one or more received signals are received over sequential periods.

FIG. 8C shows a waveform 603 representing a received signal before a magnetic nulling signal 212 is introduced. As described above, a transmit coil 100 might not be perfectly aligned with a receive coil 200 during manufacturing. Therefore, not all of the electromagnetic signal transmitted will be cancelled when received at the receive coil 200. If the coils are sufficiently misaligned, receive coil 200 will receive a small but measurable signal as represented by waveform 603. During operation, a received signal having a non-zero amplitude 603A (an amplitude above a predetermined threshold level) may falsely indicate that a metal objection is near the coils. Additionally, the greater the misalignment between a transmit coil 100 a receive coil 200, the greater the amplitude 603A of waveform 603. During calibration, the metal detector assumes that metal objects are not influencing signals received by the coils. In this case, a non-zero amplitude 603A of waveform 603 indicates that a magnetic nulling signal can be used to drive down the amplitude 603A.

FIG. 8D shows a waveform 604 representing a magnetic nulling signal 212. The magnetic nulling signal 212 is provided to an input port of the transmit amplifier 216 of transceiver circuitry 203 not being used receive signal 603. The output signal of the transmit amplifier 216 is represented as waveform 605 in FIG. 8E. This waveform 605 is used to drive the resonant circuit and to generate a magnetic nulling signal 212 transmitted from coil 200.

FIG. 8F shows a waveform 606 representing a received signal after introducing a magnetic nulling signal 212 (waveform 605). During calibration, the controller 300 adjusts waveform 604 and waveform 605 to create a magnetic nulling signal having the appropriate amplitude, phase and frequency to compensate for coil misalignment. The calibration process may be an iterative one where the controller 300 uses the receive signal 214 as a feedback signal to control the amplitude and phase of waveforms 604 and 605. The calibration processes is successful after the amplitude 606A of waveform 606 is driven to a value below the predetermined threshold level described above.

After the calibration mode, the metal detector enters an operational mode. During normal operation, the metal detector will detect both ferrous and non-ferrous metal objects. As described above, a magnetic field is concentrated by a ferrous object. In the case of a nonferrous object, eddy currents are produced in the object that, in turn, produce a magnetic field. A metal detector may determine if a metal object is ferrous or non-ferrous by comparing the phase of the transmitted signal with the phase of the received signal.

FIG. 8G shows a waveform 607 representing a received signal when the coils are in the vicinity of a ferrous metal object. FIG. 8H shows a waveform 608 representing a received signal when the coils are in the vicinity of a ferrous metal object. As shown, the relative phase difference between signals received from ferrous and non-ferrous metal objects is approximately 180 degrees.

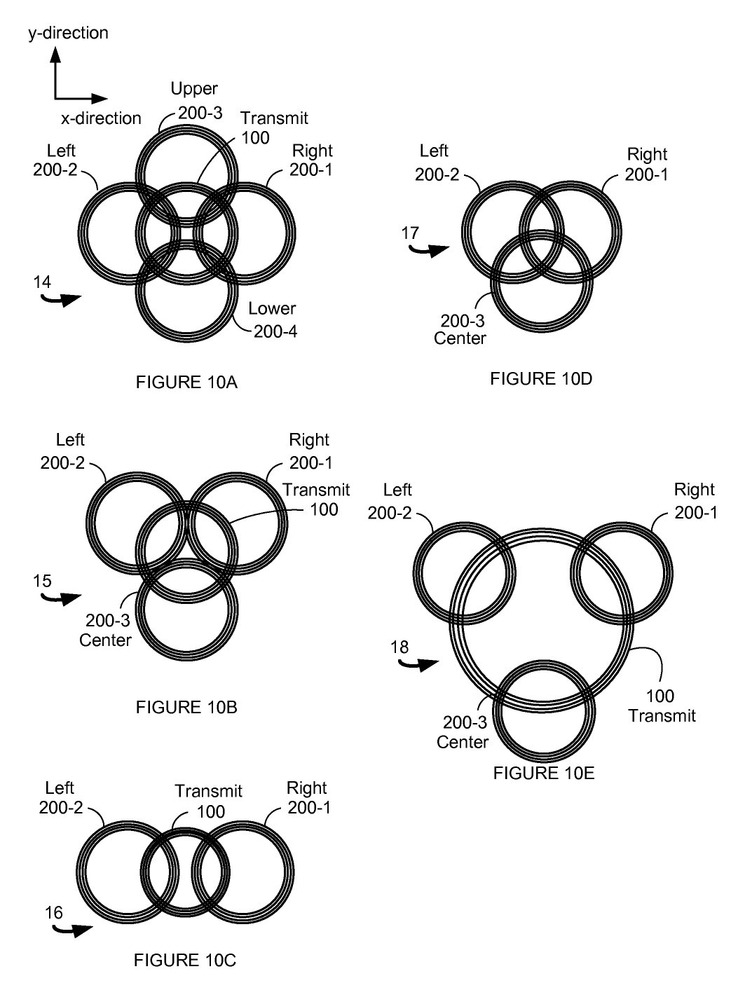

FIGS. 9A through 9F show circuitry for incorporating magnetic nulling and gradient determination, in accordance with the present invention. Each figure shows ports connections of a controller 300 implemented using a PIC18F45J10 from Microchip Technology Incorporated. The PIC18F45J10 controller is a general-purpose 8-bit RISC microcontroller and provides 32 Kbytes of Flash program memory. Alternatively, designs may incorporate other controllers, microcontrollers and microprocessors from Microchip Technology Incorporated or other manufactures.

FIG. 9A shows a PIC18F45J10 controller 300 connected to transceiver circuitry 203-1, transceiver circuitry 203-2, receive circuitry 202-3 and transmit circuitry 102. The controller 300 includes an input terminal A1 for the receive signal 214-1, an input terminal A0 for the receive signal 214-2, and an input terminal A2 for the receive signal 214-3 from respective circuits 203-1, 203-2 and 202-3. The controller 300 also includes an output terminal C3 for the magnetic nulling signal 212-1, an output terminal C1 for the magnetic nulling signal 212-2, and an output terminal C2 for the primary transmit signal 105. In an alternative embodiment, transmit amplifier 216 in transceiver circuitry 203-1 and transmit amplifier 216 in transceiver circuitry 203-2 may be implemented with a signal transmit amplifier 216 shared by both transceiver circuitry 203-1 and transceiver circuitry 203-2.

In a four coil configuration (such as described below with reference to FIGS. 10B and 10E), receive circuitry 202-3 is implemented as a receiver. In an alternative embodiment, receive circuitry 202-3 may be implemented as a third transceiver circuitry 203-3 (not shown) including both a receive amplifier 206 and a transmit amplifier 216. In a three coil configuration (such as described with reference to FIGS. 5A, 6, 10D and 10C), the receive circuitry 202-3 may be eliminated. Thus, in a three coil configuration having one transmit coil 100, a first coil (right) 200-1 and a second coil (left) 200-2, receive circuitry 202-3 is not needed.

FIG. 9B shows a detailed example embodiment of a receive amplifier 206 in receive circuitry 202 of FIG. 9A. A PIC18F45J10 controller 300 is connected to an exemplary transceiver 203, which includes a transmit amplifier 216 and receive circuitry 202. The receive circuitry 202 includes example internal circuitry of a receive amplifier 206. Each receive circuitry 202 and transceiver circuitry 203 of FIG. 9A may be implemented as shown in FIG. 9B. The transmit amplifier 216 may be shared between or among multiple transceiver circuits 203 (e.g., a single transmit amplifier 216 supporting multiple transceiver circuits 203-1 and 203-2). The controller 300 includes a first terminal (e.g., labeled C1 or C3) that is configured to provide a magnetic nulling signal 212. The controller 300 includes a second terminal (e.g., labeled A0, A1 or A2) that is configured to accept a receive signal 222. The receive amplifier 206 is shown implemented in a differential amplifier configuration. The differential amplifier configuration includes a diff amp 220 having a positive terminal connected to the first terminal of capacitor 204 and a negative terminal connected to the second terminal of capacitor 204. The diff amp 220 has an output to provide the receive signal 222 to the controller's second terminal (e.g., labeled A0, A1 or A2). The diff amp 220 is supplied from a voltage source V_{CC} coupled to a capacitor C1 234 and grounded to a common potential. The receive signal 222 from the output terminal is fed back to the negative terminal through a resistor 224 and a capacitor C2 226.

FIG. 9C shows a detailed example embodiment of a transmit amplifier 106 in transmit circuitry 102 of FIG. 9A. The transmit amplifier 106 is implemented with a NPN transistor 120 having a base connected to a first terminal of a resistor 122. The transistor 120 may be a general purpose transistor such as a 2N3904 available from a well know variety of semiconductor manufactures. The second terminal of the resistor 122 is connected to receive a transmit signal 105 (e.g., to terminal C2 of controller 300). The emitter of the NPN transistor 120 is connected to a common ground. The collector of the NPN transistor 120 is connected to a first terminal of a resistor 108. The second terminal of the resistor 108 is connected to the second terminal of capacitor 108.

FIG. 9D shows a detailed example embodiment of a transmit amplifier 216 of FIGS. 7, 9A and 9B. The transmit amplifier 216 may be formed using a diode D 217 and a resistor R1 218 connected in series. Specifically, a first terminal of the resistor R1 218 is connected to a terminal of the controller 300 sinking a magnetic nulling signal 212. A second of the resistor R1 218 is connected to the cathode of the diode D 217. The anode of the diode D 217 is connected to a first terminal of the coil 200 used to transmit the magnetic nulling signal 212. As shown in FIG. 7, for example, the second terminal of the coil 200 is connected to a middle voltage (V_{M}) that is fixed between the voltage range of the port (e.g., C1 or C3) on the controller 300. Such a configuration allows the transmit amplifier 216 the ability to create a magnetic nulling signal 212 having an amplitude and phase opposite of an otherwise un-calibrated receive signal.

FIG. 9E shows a detailed example embodiment of a middle voltage generator 250. The middle voltage generator 250 includes a voltage divider using two resistors: R1 252 and R2 254 connected in series between V_{CC} and a common ground. A differential amplifier 256 has a positive input terminal and a negative input terminal. The positive input terminal connected to a terminal between resistors R1 and R2. If R1 and R2 have equal resistances, the terminal between the two resistors provides a voltage of one half of the difference between V_{CC} and the common ground. The positive input terminal is also connected to a first terminal of a capacitor C2 258. The second terminal of the capacitor C2 258 is connected to the common ground. The negative input terminal is connected to feed back the output signal (V_{M}) of the differential amplifier 256. The differential amplifier 256 is powered with a V_{CC} signal (connected to one end of a capacitor C1 259 with the other end connected to a common ground) and the common ground.

FIG. 9F shows example interconnections from a PIC18F45J10 controller 300 to an LCD display 400 and to an audio device 430. Alternatively, other known displays and audio devices may be used. The LCD display 400 may be a multi-level gray scale dot matrix LCD display having an integrated LCD controller. In the configuration shown, the controller 300 provides data values to the LCD display 400 via an 8-bit data bus D0-D7. The controller 300 provides an LCD chip select signal (CS) via an output port (e.g., E0), an LCD reset signal (RST) via a second output port (e.g., E1), an LCD Direction control signal (DI) via another output port (e.g., B1), an LCD write signal (WR) via another port (e.g., B2) and an LCD read signal (RD) via another port (e.g., B3). As for the audio device, the audio device 430 may be a speaker or other sound device. In operation, the audio device 430 may provide a tone or a sequence of tones to indicate to a user that a metal object is nearing, is near, is far, is centered, is becoming more distant, and/or the like.

In accordance with the present invention, various coil configurations allow for injection of a magnetic nulling signal 212 and for determination of a gradient. With one transmit coil 100 and one receive coil 200, the two coil arrangement of Configuration 10 (FIG. 1) allows for detection of a metal object but does not provide for either injection of a magnetic nulling signal 212 or determination of a gradient.

An alternate arrangement of Configuration 10 provides for gradient determination. In the alternate arrangement of Configuration 10, each coil 100 and 200 is connected to individual transceiver circuitry 203 of FIG. 7. Each transceiver circuitry 203 has a capacitor 208, a receive amplifier 206, and a primary transmit amplifier 106. After initial calibration, the metal detector enters into a two-phase ping pong mode where the pair of coils swap rolls between transmitting-receiving and receiving-transmitting.

Specifically, during a first phase of operation, a first of the transceiver circuits, say transceiver circuitry 203-1, activates its primary transmit amplifier 106 and transmits a signal. The second of the transceiver circuits, say transceiver circuitry 203-2, activates its receive amplifier 206 and receives a signal. During a second phase of operation, the second of the transceiver circuits 203-2 deactivates its receive amplifier 206 and activates its primary transmit amplifier 106 to transmit a signal. The first of the transceiver circuits 203-1 deactivates primary transmit amplifier 106 and activates its receive amplifier 206 to receive a signal. The controller 300 then has samples from two coil pairings with which it may compute a gradient value to indicate left-right direction of the metal object. Additionally, the controller 300 may use the signal strength or amplitude of the received signals to approximate a depth of the metal object behind a surface. Unfortunately, without a third coil to transmit a magnetic nulling signal 212, the received signal may still have the amplitude impairments described with reference to waveform 603 in FIG. 8C.

FIGS. 10A through 10E illustrate alternative coil configurations, in accordance with the present invention. Each configuration includes coils for transmitting a primary transmit signal, for transmitting a magnetic nulling signal 212, and for receiving a receive signal. Coils used to transmit a primary transmit signal are connected to transmit circuitry 102. Alternatively, coils used to transmit a primary transmit signal are connected to transceiver circuitry 203 including a transmit amplifier such as transmit amplifier 106. Coils used to receive a receive signal are connected to transceiver circuitry 203. Alternatively, coils used to receive a receive signal are connected to receive circuitry 202 including a receive amplifier 206. Coils used to transmit a magnetic nulling signal 212 are connected to transceiver circuitry 203. Alternatively, coils used to transmit a magnetic nulling signal 212 are connected to circuitry including a transmit amplifier such as amplifier 106 or 216.

Coils used exclusively for transmitting a primary transmit signal are shown positioned in the center of the coil configuration. Non-primary transmit coils are distributed equally around the center of the coil configuration. Each pair of coils, where one may be used for transmitting a primary transmit signal and another may simultaneously be used for receiving a signal, are overlapped such that magnetic interference on the receiving coil from the transmitting coil is minimized. Furthermore, a third coil not simultaneously being used as a primary transmit coil or as a receive coil may be used to transmit a magnetic nulling signal 212. Each configuration illustrated operates in multiple phases. In a first phase of operation, a primary transmit signal is transmitted by a first coil, a magnetic nulling signal 212 transmitted by a second coil, and a receive signal is received by a third coil. For each additional phase of operation, the three signals are transmitted and received by a different sequence of three coils. Fourth or fifth coils may simultaneously be used receiving a secondary receive signal and/or for transmitting a secondary magnetic nulling signal 212.

The controller 300 determines a signal strength value from receive signals from one or more of the coils. The signal strength value may be used to estimate a gradient and a depth between a metal detector and a metal object. The controller 300 correlates receive signals from multiple coils to generate gradient values indicating a direction, with respect to the position and orientation of the metal detector. The controller 300 determines an x-gradient based on at least received signals received from two or more coils having a relative x-axis displacement from each other. Similarly, the controller 300 determines a y-gradient based on at least received signals received from two or more coils having a relative y-axis displacement from each other.

Gradient determination and depth determination is described below, however, the relative coil count, placement and size may lead to formulas appropriately modified to account for the different parameters. A multi-coil arrangement of transmit and receive coils define a physical location where each transmit-receive coil pair establishes a point in space. During operation, the controller takes measurements associated with each of these points in space. These points in space may be the center points where each transmit and receive coil pair overlap. Multiple and separate measurement points allow the controller 300 to determine a gradient or direction to the detected metal object. Points that define a line along an x-axis allow for a determination of direction along the x-axis. Points that define a plane allow for a determination of direction in the x-y plane.

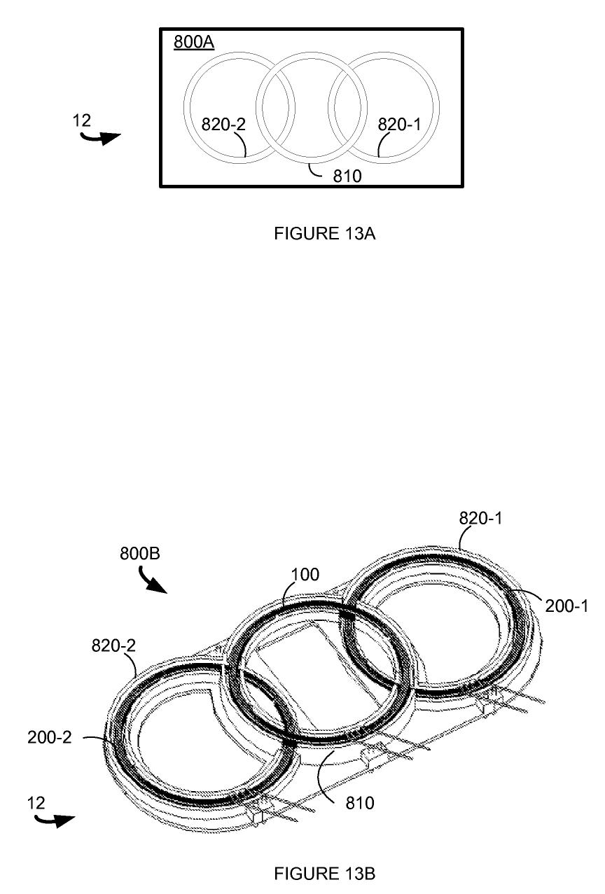

In the 3-coil system of Configuration 13 with a transmit coil having two receive coils (one on each side), there are two measurement points. The first measurement point is on to the left (L) and one to the right (R). L and R may be numerical values from an analog to digital converter taken at a sampling time. A sum value (SUM) of L and R is calculated as SUM=L+R, which represents the total signal strength. The SUM value may directly be used to indicate a depth to a metal object. A larger SUM value represents a closer metal object. A smaller SUM value represents a farther away metal object. A deflection vector includes a magnitude and a direction. For Configuration 13, the deflection vector may be considered a signed scalar value, which indicates a value along the x-axis. The L and R values may be normalized by L_{NORM}=L/SUM and R_{NORM}=R/SUM. Alternatively, the L and R values may be normalized by L_{NORM}=L/SUM−T_{L} and R_{NORM}=R/SUM−T_{R}, where T_{L} and T_{R} are minimum threshold values. The minimum threshold values may be considered the noise floor of the coil. These threshold values may be equal or individually set during calibration (at 720 described below with reference to FIG. 12). The deflection value (DEFL) may be calculated as DEFL_{RAW}=[−L_{NORM}+R_{NORM}]. The raw deflection value may be scaled to suit the geometry of a particular display. For example, DEFL_{SCALED}=DEFL_{RAW}*M_scale, where M_scale is a multiplier constant to set the gain of the deflection value to fit, for example, the number of pixels on a digital graphic display. In this configuration, if L and R are equal, the deflection value will be zero and the display should be centered. If L is larger than R, the deflection value will be negative. If R is larger than L the deflection value will be positive. The deflection value therefore may be used to display a relative left or right direction to the detected metal object. For a display of a particular dimension, the deflection value may be scaled to accommodate a maximum deflection value.

In the 4-coil system of Configuration 15 with a transmit coil surrounded by 3 receiving coils there are three measurement points, arranged as the points on an equilateral triangle surrounding the center transmit coil. The first measurement point is up and left (L), the second measurement point is up and right (R), and the third measurement point is down and center (C). A sum value (SUM) of L, R and C is calculated as SUM=L+R+C, which represents the total signal strength. A deflection vector includes a magnitude and a direction in the x-y plane. The deflection vector may be computed by normalizing each of the L, R and C measurements as L_{NORM}=L/SUM, R_{NORM}=R/SUM and C_{NORM}=C/SUM. Alternatively, the L, R and C values may be normalized by L_{NORM}=L/SUM−T_{L}, R_{NORM}=R/SUM−T_{R} and C_{NORM}=C/SUM−T_{C}, where T_{L}, T_{R} and T_{C} are minimum threshold values as described above. These normalized values represent how far the deflection vector should be biased or directed toward each of the three normalized vector directions. Next, decompose each of these vectors into their x-y coordinates, then sum the x-axis components of each normalized measurement and sum the y-axis components of each normalized measurement as follows: X_{RAW}=[cos(150)*L_{NORM}]+[cos(30)*R_{NORM}]+[cos(−90)*C_{NORM}]; and Y_{RAW}=[sin(150)*L_{NORM}]+[sin(30)*R_{NORM}]+[sin(−90)*C_{NORM}].

Furthermore, a scaling value may be applied to fit a maximum deflection value that may be shown on a particular display. For example, X_{SCALED}=X_{RAW}*X_scale and Y_{SCALED}=Y_{RAW}*Y_scale. In Configuration 15, the L, R and C measurement points are 150, 30 and −90 degrees, respectively, with reference to the x-axis. Equivalently, the coil configuration may be rotated or flipped thus defining a different set of angles from a center point to each of the measurement points. To simplify the arithmetic in a controller 300, approximations for cosine and sine may be made (e.g., cos(30)=0.866 and sin(30)=0.5).

FIG. 10A shows Configuration 14 having five coils. Configuration 14 includes a transmit coil 100, a right coil 200-1, a left coil 200-2, an upper coil 200-3 and a lower coil 200-4. From an overhead view, the transmit coil 100 is positioned at the center of the four other coils, with the right coil 200-1 positioned to the right of the transmit coil 100, the left coil 200-2 positioned to the left, the upper coil 200-3 positioned above of the transmit coil 100, and the lower coil 200-4 positioned below. The transmit coil 100 is connected to transmit circuitry 102 and each of the other coils 200 are connected to respective receive circuitry 202 or transceiver circuitry 203.

During each phase of operation, the transmit coil 100 transmits a primary transmit signal, a first of the other coils 200 receives a receive signal, and a second of the other coils 200 transmits a magnetic nulling signal 212. For example, during a first phase while the transmit coil 100 is transmitting, the right coil 200-1 receives a receive signal and the lower coil 200-4 transmits a magnetic nulling signal 212. During a second phase, the left coil 200-2 receives a receive signal and the lower coil 200-4 transmits a magnetic nulling signal 212. During a third phase, the upper coil 200-3 receives a receive signal and the left coil 200-2 transmits a magnetic nulling signal 212. Finally, during a fourth phase, the lower coil 200-4 receives a receive signal and the left coil 200-2 transmits a magnetic nulling signal 212. The controller 300 correlates receive signals from the right coil 200-1 and left coil 200-2 to determine an x-direction gradient and receive signals from the upper coil 200-3 and a lower coil 200-4 to determine a y-direction gradient.

FIG. 10B shows Configuration 15 having four coils. Configuration 15 includes a transmit coil 100, a right coil 200-1, a left coil 200-2 and a center coil 200-3. From an overhead view, the transmit coil 100 is seen positioned at the center of the three coils, with the three coils equally spaced around the transmit coil 100. The right coil 200-1 is positioned at approximately two o'clock with respect to the transmit coil 100, the left coil 200-2 is positioned at approximately ten o'clock, and the upper coil 200-3 is positioned at six o'clock. To provide a magnetic nulling signal 212, any two or more of the coils 200 connected to a transmit amplifier 216 in respective transceiver circuitry 203. In Configuration 15, the right coil 200-1 and left coil 200-2 pair combine to provide received signals used to determine an x-direction gradient. The controller 300 correlates receive signals from the right coil 200-1 and/or left coil 200-1 along with the center coil 200-3 to determine a y-direction gradient.

FIG. 10C shows Configuration 16 having three coils. Configuration 16 includes a transmit coil 100, a right coil 200-1 and a left coil 200-2. From overhead, the transmit coil 100 is positioned at the center between the right coil 200-1 and the left coil 200-2. The right coil 200-1 is positioned at three o'clock with respect to the transmit coil 100 and the left coil 200-2 is positioned at nine o'clock. To provide a magnetic nulling signal 212, the coil 200 not being used as a receive coil may be used to transmit a magnetic nulling signal 212. For example, when the right coil 200-1 is active receiving a receive signal and the transmit coil 100 is transmitting a primary transmit signal, the left coil 200-2 may be used to transmit a magnetic nulling signal 212. During the next phase of operation, the right coil 200-1 transmits a magnetic nulling signal 212, the left coil 200-2 receives a receive signal and the transmit coil 100 transmits a primary transmit signal. The controller 300 determines an x-direction gradient value from by correlating receive signals from the right coil 200-1 and left coil 200-2. Since Configuration 16 does not have a coil positioned in the y-direction, insufficient date exists to determine a y-direction gradient.

FIG. 10D shows Configuration 17 having three coils. Configuration 17 includes a right coil 200-1, a left coil 200-2 and a center coil 200-3. The coils are positioned such that each coil overlaps with the other two coils to provide positional magnetic nulling. The coils 200 are each attached to a transceiver circuitry 203. In operation, a first coil transmits a primary transmit signal, a second coil transmits a magnetic nulling signal 212 and a third coil receives a receive signal. To acquire sufficient positional diversity, each coil performs a different function during different phases of operation. For example, during a first phase of operation, the right coil 200-1 transmits a primary transmit signal, the left coil 200-2 transmits a magnetic nulling signal 212 and the center coil 200-3 receives a receive signal. During the second phase of operation, the right coil 200-1 transmits a magnetic nulling signal 212, the left coil 200-2 receives a receive signal and the center coil 200-3 transmits a primary transmit signal. During the third phase of operation, the right coil 200-1 transmits receives a receive signal, the left coil 200-2 a primary transmit signal and the center coil 200-3 transmits a magnetic nulling signal 212.

Though configurations 12 through 15 and 17 are each shown having coils of a similar radius, a common radius is not necessary. A coil having a small radius may be used to sense a lateral displacement of a nearby metal object where as a coil have a larger radius may be used to sense a metal object that is farther away or deeper.

FIG. 10E shows Configuration 18 having four coils similar to the four coil configuration of FIG. 10B. The transmit coil 100, however, is substantially larger in diameter than the three equally distributed receive/transceiver coils: right coil 200-1, left coil 200-2 and center coil 200-3. Such relative coil diameters allows for a metal detector that is better able to sense deeper metal objects.

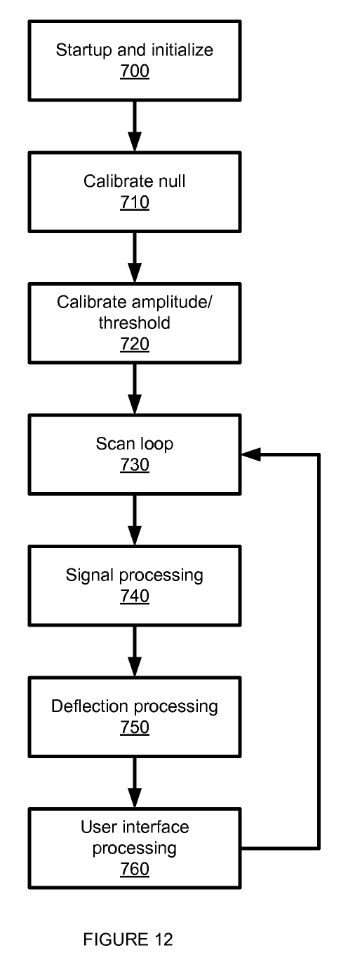

FIGS. 11A and 11B demonstrate a one-dimension-plus-depth display and a two-dimension-plus-depth display, in accordance with the present invention. FIG. 11A illustrates a display 410 showing two dimensions: one lateral dimension (x direction) plus one dimension indicating depth. The rectangular LCD display 410 of a metal detector viewable by a user. The LCD display 410 may include a pair of chevrons 414A, 414B or the like to indicate a centerline 414 of the metal detector. The centerline 414 may be an imaginary or actual delineated line electronically displayed. When the controller 300 detects the presents of a metal object, the controller 300 computes a lateral distance and a direction from the centerline 414 along the x axis to the metal object. The controller 300 also computes a depth to the metal object with reference to the metal detector and whether the metal is exhibits ferrous or non-ferrous properties. After computation, the controller 300 instructs the display 410 to (1) draw an icon 412 at a position reflecting the computed distance and direction from the centerline 414 to the metal object along the x axis; (2) indicate the computed depth 416; and (3) indicate whether the metal is ferrous or non-ferrous. Additionally, the area of the icon 412 may become larger or smaller to reflect whether the metal object is closer or farther away.

FIG. 11B illustrates a display 420 showing three dimensions: two lateral dimensions (x direction and y direction) plus one dimension indicating depth. The rectangular LCD display 420 may include two pairs of chevrons 414A, 414B and 424A, 424B or the like to indicate a vertical centerline 414 and a horizontal centerline 424 of the metal detector. The centerlines 414 and 424 may be imaginary or actual delineated lines. When the controller 300 detects the presents of a metal object, the controller 300 computes a lateral distance and direction from the vertical centerline 414 to the metal object along the x axis and a lateral distance and direction from the horizontal centerline 424 to the metal object along the y axis. Again, the controller 300 computes a depth to the metal object and whether the metal is ferrous or non-ferrous. After computation, the controller 300 instructs the display 420 to (1) draw an icon 422 at a position reflecting the computed distances and direction from the centerlines 414, 424; (2) indicate the computed depth 416; and (3) indicate whether the metal is ferrous or non-ferrous. Once more, the area of the icon 422 may become larger or smaller to reflect whether the metal object is closer or farther away.

FIG. 12 shows a software block diagram of a metal detector, in accordance with the present invention. At 700 (startup and initialize), a user activates the metal detector. Power is provided to the controller 300, which executes boot and diagnostic code preprogrammed into its flash memory. During initialization, the controller 300 initializes variables, starts the user interface, activates the display, sets up internal peripherals of the controller 300, initializes timers and initializes analog to digital converters. In some embodiments, after initialization and before the nulling calibration is complete, a receive signal after the amplification may be between 0 and 2 V peak to peak (V_{PP}) when no metal objects are in the vicinity of the metal detector.

At 710 (calibrate null), each receive channel is calibrated individually. A transmit signal is transmitted from a transmit coil 100 and a receive signal is amplified and sampled from the receive coil 200 for that receive channel. After the receive signal settles, the controller 300 measures and averages the receive signal. If the averaged receive signal is outside a tolerable level, the controller 300 determines a first nulling signal in terms of nulling parameters (e.g., magnitude, polarity and/or phase) of a magnetic nulling signal to be applied for each of the receive channels. At this point, the controller 300 may test nulling with the determined nulling parameters. If necessary, the determined nulling parameters may be adjusted such that the averaged receive signal is with the tolerable level. This procedure may be performed for each receive channel to determine a second and additional nulling signals if needed. A set of nulling parameters, one for each receive channel, may be stored to memory for later access during normal run time operation.

At 720 (calibrate amplitude/threshold), the controller 300 measures the amplified receive signal after applying nulling. After the magnetic nulling and/or electrical nulling, an amplified receive signal may be less than 1.0 V peak to peak (V_{PP}) with no metal object present. This amplified receive signal is used to determine a minimum threshold (e.g., T_{L}, T_{R} or T_{C}) at which future receive signals will be compared. For example, if a future receive signal greater than this minimum threshold will indicate the presents of a metal object. The controller 300 may determine a separate threshold amplitude for each receive channel while the metal detector is substantially distant from the metal.

At 730 (scan loop), each receive channel is sequentially exercised. During a first phase of operation, a first receive channel is activated. A primary transmit signal is transmitted from a first coil 100 of a first resonate circuit, a magnetic nulling signal is transmitted from a second coil 200 of a second resonate circuit and a receive signal is received from a third coil 200 of a third resonate circuit. The receive circuitry amplifies the receive signal, which is digitized by the controller 300. During a second phase of operation, a second receive channel is activated and so on for each subsequent phase of operation.

For example, Configuration 13 has two phases of operation (e.g., in a first phase, coil 100 is used to transmit the primary transmit signal, coil 200-2 is used to transmit a magnetic nulling signal, and coil 200-1 is used to receive a receive signal; and in a second phase, coil 100 is again used to transmit the primary transmit signal, coil 200-1 is used to transmit a magnetic nulling signal, and coil 200-2 is used to receive a receive signal). Configuration 15 has three phases of operation (e.g., in a first phase, coil 100 is used to transmit the primary transmit signal, coil 200-2 is used to transmit a magnetic nulling signal, and coil 200-1 is used to receive a receive signal; in a second phase, coil 100 is used to transmit the primary transmit signal, coil 200-1 is used to transmit a magnetic nulling signal, and coil 200-2 is used to receive a receive signal; and in a third phase, coil 100 is used to transmit the primary transmit signal, coil 200-1 is used to transmit a magnetic nulling signal, and coil 200-3 is used to receive a receive signal). Configuration 17 also has three phases of operation (e.g., in a first phase, coil 200-1 is used to transmit the primary transmit signal, coil 200-2 is used to transmit a magnetic nulling signal, and coil 200-3 is used to receive a receive signal; in a second phase, coil 200-2 is used to transmit the primary transmit signal, coil 200-3 is used to transmit a magnetic nulling signal, and coil 200-1 is used to receive a receive signal; and in a third phase, coil 200-3 is used to transmit the primary transmit signal, coil 200-1 is used to transmit a magnetic nulling signal, and coil 200-2 is used to receive a receive signal). For each receive channel processed, respective receive signals are collected. The controller 300 then performs signal processing (740) and deflection processing (750) before displaying results to an operator during user interface processing (760).

At 740 (signal processing), the collected receive signals are averaged and compared to the minimum threshold described above at 720. If a received signal is greater than the minimum threshold (e.g., greater than T_{L}, T_{R} or T_{C}), a metal object may be nearby. The minimum threshold may be considered a noise level and may be subtracted from the averaged receive signal value as describe above. Next, the averaged receive signal values may be summed to provide an overall signal strength. The overall signal strength may be used to indicated a depth of a metal object. The overall signal strength is also used to normalize the averaged signals as described above.

At 750 (deflection processing), the controller 300 uses the normalized averaged received signal values to compute a deflection vector. The deflection vector indicates the direction to the metal object. An x-axis component of the deflection vector may be computed by summing the x-axis components of each receive signal. Similarly, the y-axis component of the deflection vector may be computed by summing the y-axis components of each receive signal. In some embodiments, the raw deflection vector is scaled with a linear multiplier (e.g., M_scale, X_scale or Y_scale). In other embodiments, the raw deflection vector is logarithmically scaled to adjust the offset from center to the metal object. Similarly, the depth may be determined from as a summation (SUM) of the signal strengths. This summation may be linearly scaled or logarithmically scaled to produce an estimated depth to the metal object.

At 760 (user interface processing), the controller 300 instructs the display to show an indication of the depth and a 1-D or 2-D offset from center to the metal object. An indication of whether the metal object is ferrous or non-ferrous may also be displayed. When the normalized received values are equal, a visual and/or an audio indication may be made.

In Configuration 13, when L and R are both above a minimum threshold value and are within a second small threshold value from each other, the metal detector is centered over the metal object. If the metal detector and metal object are not centered, the display indicates an x-axis direction or offset from a center line of the metal detector to the metal object based on the determined gradient. In Configuration 15, when L, R and C are above a minimum threshold value and X_{SCALED} and Y_{SCALED} are both below a second small threshold value, the metal detector is centered over the metal object. At this time, the display may show the word “CENTER” or “CENTERED” and the audio device may sound a distinctive beeping noise. If the metal detector and metal object are not vertically centered, the display indicates an x-axis direction or offset from a vertical center line of the metal detector to the metal object based on the determined gradient. The direction may be an arrow or the like. An offset may be a numerical value, such as inches to the metal object or may be indicated as a variable size, area or width. If the metal detector and metal object are not horizontally centered, the display indicates a y-axis direction or offset from a horizontal center line of the metal detector to the metal object based on the determined gradient. Furthermore, the display may display graphics and incorporate graphics smart-erasing as well as provide gradient edge smoothing at appropriate conditions of depth.

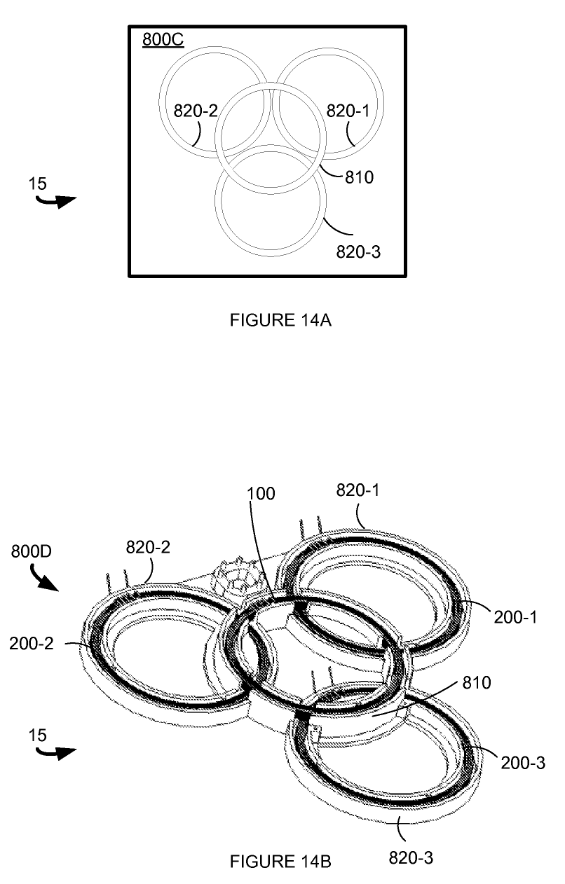

FIGS. 13A, 13B, 14A and 14B illustrate form moldings for holding coils in place for positional magnetic nulling, in accordance with the present invention. Such forms provide for ease of manufacturing of a high volume of metal detectors. During a conventional manufacturing process, a technician fixes a first coil to a substrate. Next, the technician places a second coil on the substrate overlapping with the first coil and finely adjust the relative positioning between the two coils until test equipment shows that the receiving coil is magnetically nulled with respect to the transmitting coil. The process repeats again for each additional receive coil. Manually adjusting the relative position between two coils is a labor intensive and tedious task. A form as described below allows for placement of coils without tedious testing. The forms may be configured such that during assembly coils are constructed inside (or prefabricated then placed inside) a plastic coil-holder frame or track that accurately positions the coils with respect to each other.

FIG. 13A shows an overhead view of a mold 800A having forms for three coils. A transmit coil 100 (not shown) may be positioned in a form defining a first track 810, a right receive coil 200-1 (not shown) may be positioned in a second track 820-1 and a left receive coil 200-2 (not shown) may be positioned in a third track 820-2, thereby forming Configuration 12.

FIG. 13B shows the perspective view of another mold 800B having forms for three coils. The mold 800B contains a first track 810, a second track 820-1 and a third track 820-2. During manufacturing a technician may place the right receive coil 200-1 in the second track 820-1 and the left receive coil 200-2 in the third track 820-2. Next the technician may place the transmit coil 100 into the first track 810, thereby forming Configuration 12.

FIG. 14A shows an overhead view of a mold 800C having forms for four coils. A transmit coil 100 (not shown) may be positioned in a first track 810, a right receive coil 200-1 (not shown) may be positioned in a second track 820-1, a left receive coil 200-2 (not shown) may be positioned in a third track 820-2, and a third receive coil 200-3 (not shown) may positioned in a fourth track 820-3, thereby forming Configuration 15.

FIG. 14B shows the perspective view of another mold 800D having forms for four coils. The mold 800D contains a first track 810, a second track 820-1, a third track 820-2, and a fourth track 820-3. During manufacturing a technician may place the right receive coil 200-1 in the second track 820-1, the left receive coil 200-2 in the third track 820-2, and the. Next the technician may place the transmit coil 100 into the first track 810, thereby forming Configuration 12. The need for fine positioning and manufacturing tested maybe eliminate it. For each of the molds described above the need for fine positioning and manufacturing tested maybe eliminate it.

To minimize the adverse impact that metallic material inside the metal detector has on sensitivity, a coil molding should allow positioning of the coils at a substantial distance away from the metallic material. Metallic material placed too close to the coils degrades coil sensitivity in detecting metal objects. In some embodiments, metallic materials within the metal detector, such as electronic circuitry, is positioned at least 1.5 inches away from the coils.

The description above provides various hardware embodiments of the present invention. Furthermore, the figures provided are merely representational and may not be drawn to scale. Certain proportions thereof may be exaggerated, while others may be minimized. The figures are intended to illustrate various implementations of the invention that can be understood and appropriately carried out by those of ordinary skill in the art. Therefore, it should be understood that the invention can be practiced with modification and alteration within the spirit and scope of the claims. The description is not intended to be exhaustive or to limit the invention to the precise form disclosed. It should be understood that the invention can be practiced with modification and alteration.

What is claimed is:

1. A metal detector comprising:
a first resonant circuit comprising a first coil, wherein the first resonant circuit is configured to transmit a first circuit transmit signal;
a second resonant circuit comprising a second coil, wherein the second resonant circuit is configured to receive a second circuit receive signal;
a third resonant circuit comprising a third coil, wherein the third resonant circuit is configured to receive a third circuit receive signal; and
a controller comprising logic to determine a gradient, variable in at least one dimension, based on the second circuit receive signal and the third circuit receive signal.

2. The metal detector of claim 1, further comprising:
a fourth resonant circuit comprising a fourth coil, wherein the fourth resonant circuit is configured to receive a fourth circuit receive signal, and wherein the fourth coil is positioned to define a plane from a center of the second coil, a center of the third coil and a center of the fourth coil;
wherein the gradient is variable in at least two dimensions and is further based on the fourth circuit receive signal.

3. The metal detector of claim 1, further comprising:
a fourth circuit comprising at least one secondary transmit amplifier having an output port coupled to at least one of the second coil and the third coil and configured to transmit a nulling signal to the at least one of the second coil and the third coil;
wherein the controller further comprises logic to determine the nulling signal for each of the at least one of the second coil and the third coil based on the second circuit receive signal and the third circuit receive signal.

4. The metal detector of claim 1, wherein:
the first resonant circuit further comprises a primary transmit amplifier having an output port coupled to the first coil;
the second resonant circuit further comprises a receive amplifier having an input port coupled to the second coil; and
the third resonant circuit further comprises a receive amplifier having an input port coupled to the third coil.

5. The metal detector of claim 1, wherein:
the controller further comprises logic to determine a depth based on at least one of the second circuit receive signal and the third circuit receive signal.

6. The metal detector of claim 1, wherein the first, second and third resonant circuits operate at a frequency between 1 kHz and 10 kHz.

7. The metal detector of claim 1, wherein each of the first, second and third resonant circuits is a tank circuit comprising a capacitor in parallel with the coil.

8. A metal detector comprising:
a first resonant circuit comprising a first coil and a transmit amplifier having an output coupled to the first coil, wherein the first resonant circuit is configured to transmit a first circuit transmit signal;
a second resonant circuit comprising a second coil and a receive amplifier having an input couple to the second coil, wherein the second resonant circuit is configured to receive a second circuit receive signal;
a third resonant circuit comprising a third coil and a secondary transmit amplifier having an output coupled to the third coil, wherein the third circuit is configured to transmit a third circuit nulling signal; and
a controller comprising logic to determine the third circuit nulling signal based on the second circuit receive signal.

9. The metal detector of claim 8, wherein:
the second resonant circuit is further configured to transmit a second circuit nulling signal;
the third resonant circuit is further configured to receive a third circuit receive signal; and
the controller further comprises logic to determine the second circuit nulling signal based on the third circuit receive signal.

10. The metal detector of claim 9, wherein the second resonant circuit further comprises a transmit amplifier having an output port coupled to the second coil.

11. A method of determining a gradient relative to a metal detector and metal hidden behind a surface, the method comprising:
transmitting, from a first resonant circuit, a first circuit transmit signal;
receiving, from a second resonant circuit, a second circuit receive signal;
receiving, from a third resonant circuit, a third circuit receive signal; and
determining a gradient based on the second circuit receive signal and the third circuit receive signal.

12. The method of claim 11, further comprising determining a receive signal amplitude threshold to indicate whether a receive signal is determined to be detected.

13. The method of claim 11, further comprising:
receiving, from a fourth resonant circuit, a fourth circuit receive signal;
wherein the gradient is further based on the fourth circuit receive signal.

14. The method of claim 11, further comprising displaying an indication of a first direction in a first dimension between a first center line of the metal detector and the metal based on the determined gradient.

15. The method of claim 14, further comprising displaying an indication of a first offset in a first dimension between a first center line of the metal detector and the metal based on the determined gradient.

16. The method of claim 14, further comprising displaying an indication of a second direction in a second dimension between a second center line of the metal detector and the metal.

17. The method of claim 14, further comprising displaying an indication of a second offset in a second dimension between a second center line of the metal detector and the metal.

18. The method of claim 11, further comprising:
determining a first nulling signal; and
transmitting the first nulling signal.

19. The method of claim 18, wherein the act of determining first nulling signal comprises determining a nulling signal to drive the second circuit receive signal to a minimum threshold when the metal detector is substantially distant from the metal.

20. The method of claim 18, wherein the act of transmitting the first nulling signal comprises transmitting, from a third resonant circuit, a third circuit transmit signal based on the first nulling signal.

21. The method of claim 11, further comprising displaying an indication of detection of at least on of a ferrous metal and a non-ferrous metal.

22. The method of claim 11, further comprising displaying an indication of depth of the metal.

23. A method of determining a gradient relative to a metal detector and metal hidden behind a surface, the method comprising:
generating a primary transmit signal, generating a magnetic nulling signal and measuring a sequence of receive signals from a first receiver channel;
averaging the sequence of receive signals from the first receiver channel to form a first average value;
generating a primary transmit signal, generating a magnetic nulling signal and measuring a sequence of receive signals from a second receiver channel;
averaging the sequence of receive signals from the second receiver channel to form a second average value;
normalizing the first and second average values; and
computing an offset from a centerline in a first dimension based on a component of the first and second average values in the direction of the first dimension.

24. The method of claim 13, further comprising:
generating a primary transmit signal, generating a magnetic nulling signal and measuring a sequence of receive signals from a third receiver channel;
averaging the sequence of receive signals from the third receiver channel to form a third average value;
normalizing the third average value; and
computing an offset from a centerline in a second dimension perpendicular to the first dimension based at least on a component of the first and third average values in the direction of the second dimension.

25. A method of magnetically nulling, the method comprising:
transmitting a primary transmit signal from a first coil;
receiving a first receive signal from a second coil for first receiver channel;
amplifying the received signal;
determining parameters for a first magnetic nulling signal based on the first receive signal; and
transmitting the first magnetic nulling signal from a third coil while receiving a second receive signal from the second coil for the first receiver channel.

26. The method of claim 25, further comprising:
updating the nulling parameters based on the second receive signal; and
saving the nulling parameters to memory.
